(19) United States
(12) Patent Application Publication
(10) Pub. No.: US 2002/0025037 A1
(43) Pub. Date: Feb. 28, 2002

(54) Encryption/decryption apparatus, authenticating apparatus, program and method

(76) Inventor: Fumihikko Sano, Fuchu-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 09/920,737

(22) Filed: Aug. 3, 2001

(30) Foreign Application Priority Data
Aug. 4, 2000 (JP) 2000-237268

(51) Int. Cl. H04L 9/00

(52) U.S. Cl. 380/44

(57) ABSTRACT

According to each embodiment of the present invention, generation of key data different from each other can be guaranteed and the safety can be improved without providing a device for eliminating input of a specific pattern. Specifically, key data Kg2 to Kgm are generated by converting a common key K based on variables v₁ to vₘ₋₁ inputted independently from plain text blocks P1 to Pm or intermediate results i₁ to iₘ₋₁. Therefore, in each embodiment of the present invention, even if the apparatus is attacked by a decryption technique by which the respective plain text blocks P1 to Pm are inputted as the same data, the key data Kg2 to Kgm can be created as values different from each other.

### CROSS-REFERENCE TO RELATED APPLICATIONS

This application is based upon and claims the benefit of priority from the prior Japanese Patent Application No. 2000-237268, filed Aug. 4, 2000, the entire contents of which are incorporated herein by reference.

### BACKGROUND OF THE INVENTION

1. Field of the Invention

The present invention relates to an encryption/decryption apparatus using an encryption chaining system in a block cipher, an authenticating apparatus, program and method.

2. Description of the Related Art

In recent years, in the field of a computers and communications technology, there is widely known a cipher technique for encryption transmission data to be transmitted and decryption received data in order to obtain the content. In this type of cipher technique, an algorithm using the same private key (which will be referred to as a common key) is referred to as a common key encryption system. In the common key encryption system, plain text data to be inputted is generally divided into blocks having a fixed length, and each block is subjected to agitation processing based on a key generated from the common key and converted into a cipher text.

Here, if the plain text data is longer than a block length of the encryption algorithm, the input data is divided by the block length, and results of encryption are combined by a well-known encryption chaining system such as a CBC mode (cipher block chaining mode), an inner CBC mode and a CBCM mode.

FIG. 1 is a type drawing showing a structure of an encryption/decryption apparatus to which this type of encryption chaining system is applied. In this encryption apparatus, the inputted plain text data is divided in m plain text blocks P1 to Pm having a fixed length, and the respective plain text blocks P1 to Pm are inputted to any of m encryption functions F1 to Fm arranged in parallel to each other. The respective encryption functions F1 to Fm encipher the inputted plain text blocks P1 to Pm by using key data based on the common key K, converts them into cipher text blocks C1 to Cm, and outputs them. Incidentally, when the cipher text blocks C1 to Cm are inputted, the encryption/decryption apparatus deciphers these cipher text blocks C1 to Cm by a processing opposite to the encryption, converts them into the plain text blocks P1 to Pm, and outputs them.

Here, when the first plain text block P1 and the common key K are inputted, a first encryption function F1 inputs a first intermediate output i₁ to a first conversion function f₁ and, on the other hand, outputs the cipher text C1.

As the first conversion function f₁, for example, a non-linear function is used, and this function converts the intermediate output i₁ of the encryption function F1 and inputs an obtained conversion result s₁ to the first conversion function g₁. It is to be noted that this is also applicable to second to (m−1)-th conversion functions f₂ to fₘ₋₁ Further, all the conversion functions f₁ to fₘ₋₁ are conversion equal to each other.

As the first conversion function g₁, for example, a linear function such as exclusive OR or addition is used, and this function converts the separately inputted common key K based on the conversion result s₁ of the conversion function f₁ and inputs an obtained conversion result Kg2 to a second encryption function F2. Furthermore, this is also applicable to second to (m−1)-th conversion functions g₂ to gₘ₋₁. Moreover, all the conversion functions g₁ to gₘ₋₁ are equal to each other.

Thereafter, in a similar manner, the common key K is converted into key data Kgn (where 2≦n≦m) based on an intermediate output iₙ₋₁ by the (n−1)-th encryption function F(n−1) and the (n−1)-th conversion functions fₙ₋₁ and gₙ₋₁, and inputted to the n-th encryption function Fn as the key data Kgn. The processing for generating the key data Kgn on the next stage from the intermediate output iₙ₋₁ on the preceding stage and the common key K is performed till the key data Kgm is inputted to the m-th encryption function Fm. It is to be noted that the common key K inputted to the respective conversion functions g₁ to gₘ₋₁ is the same as the common key K inputted to the first encryption function F1.

In this encryption chaining system, since the keys K and Kg2 to Kgm used for m encryption functions F1 to Fm are different from each other, the high safety is provided.

In the above-described encryption chaining system, however, when the plain text blocks P1 to Pm equal to each other are inputted, the conversion results s₁ to sₘ₋₁ of all the conversion functions f₁ to fₘ₋₁ become 0. In addition, the conversion results Kg2 to Kgm obtained by converting the common key K by the conversion functions g₁ to gₘ₋₁ coincide with the common key K.

Incidentally, when the respective keys K and Kg2 to Kgm match each other, the same encryption is executed with the m encryption functions F1 to Fm, and the same m cipher text blocks C1, C2 and C3, . . . , Cm are outputted. This phenomenon affords an important clue to decryption and deteriorates the safety against the decryption technique.

As described above, in the prior art encryption/decryption apparatus using the encryption chaining system, outputs of all the conversion functions f₁ to fₘ₋₁ may, in some cases, become 0 and the common K may not be converted due to input of the plain text blocks P1 to Pm having a specific pattern. In order to avoid this, the plain text blocks P1 to Pm or the keys Kg2 to Kgm must be carefully examined so as to prevent the outputs of the conversion functions f1 to fₘ₋₁ from becoming 0.

This examination can be realized by adding a device for eliminating the input of the plain text blocks P1 to Pm having a specific pattern. However, the technique for adding this type of elimination device produces a problem of an increase in the cost and scale of the encryption chaining system.

Additionally, this elimination device does not contribute to the improvement of the cipher strength. That is, in view of cost effectiveness, any other technique which can improve the cipher strength is desired.

### BRIEF SUMMARY OF THE INVENTION

It is an object of the present invention to provide an encryption/decryption apparatus, an authenticating apparatus, an program and a method which can guarantee generation of key data different from each other and improve the safety without providing a device for eliminating the input of a specific pattern.

According to a first aspect of the present invention, there is provided an encryption/decryption apparatus comprising: a plurality of encryption function portions which are provided in parallel to each other which encrypt plain text data in accordance with each block based on key data to output cipher text data, and/or decrypt the cipher text data based on the key data to output the plain text data; and a plurality of means for generating key data which convert a common key based on an intermediate processing result of any of the encryption function portions and individually input obtained key data to any of the encryption function portions before starting processing, wherein each of the means for generating key data converts the common key by using any conversion processing among two or more types of conversion processing different from each other.

Further, according to a second aspect of the present invention, there is provided an authenticating apparatus which comprises authenticator generating means for generating an authenticator from a message and authenticates the message based on the authenticator generated by the authenticator generating means, wherein the authenticator generating means comprises: a plurality of encryption function portions which are provided in parallel to each other and encrypt the message in accordance with each block based on key data to generate cipher text data; a plurality of key data generation portions which convert a common key based on an intermediate processing result of any of the encryption function portions and any one of two or more types of conversion processing different from each other, and individually input obtained key data to any of the encryption function portions; and an authenticator generation portion for generating the authenticator based on the cipher text data generated by an encryption function portion on a last stage.

Here, the first and second aspects of the present invention may be realized by using a computer-readable storage medium, storing therein a program for carrying out above-described functions. Further, the first and second aspects of the present invention are not restricted to the invention of the apparatus or the storage medium and may be realized as the invention of a method.

Therefore, since the first aspect of the present invention takes the above-described means, each means for generating key data used in the encryption chaining system converts the common key by using any conversion processing among two or more types of conversion processing different from each other.

As a result, since the key data which is a conversion result of the common key is not uniquely determined from the plain text data, generation of the key data different from each other can be guaranteed and the safety can be improved without providing a device for eliminating input of a specific pattern.

Furthermore, the second aspect of the present invention can realize an authenticating technique demonstrating the effect of the first aspect since the encryption/decryption apparatus according to the first aspect is used when producing an authenticator.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently embodiments of the invention, and together with the general description given above and the detailed description of the embodiments given below, serve to explain the principles of the invention.

FIG. 1 is a type drawing showing a structure of an encryption/decryption apparatus to which a prior art encryption chaining system is applied;

FIG. 2 is a type drawing showing a structure of an encryption/decryption apparatus to which an encryption chaining system according to a first embodiment of the present invention is applied;

FIG. 3 is a flowchart showing an example of a method for generating each variable in the first embodiment;

FIG. 4 is a type drawing showing the functions of a program in the first embodiment;

FIG. 5 is a type drawing showing a structure of an encryption/decryption apparatus to which an encryption chaining system according to a second embodiment of the present invention is applied;

FIG. 6 is a type drawing showing the functions of a program in the second embodiment;

FIG. 7 is a type drawing showing structures of first and second entity devices to which an authenticating system according to a third embodiment of the present invention is applied;

FIG. 8 is a type drawing typically showing a structure of an MAC calculation portion in the third embodiment;

FIG. 9 is a type drawing showing the functions of a program in the third embodiment; and

FIG. 10 is a type drawing showing a structure of an MAC calculation portion to which a cipher block chaining system according to a fourth embodiment of the present invention is applied.

### DETAILED DESCRIPTION OF THE INVENTION

Each embodiment according to the present invention will now be described hereinafter with reference to the accompanying drawings.

### First Embodiment

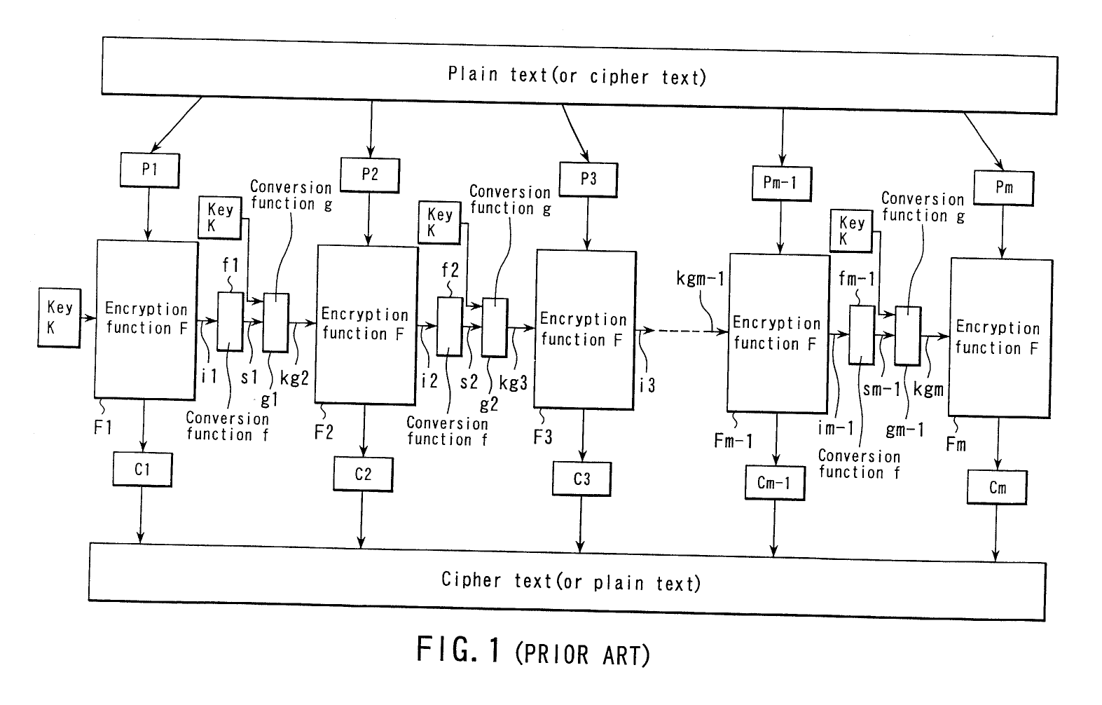

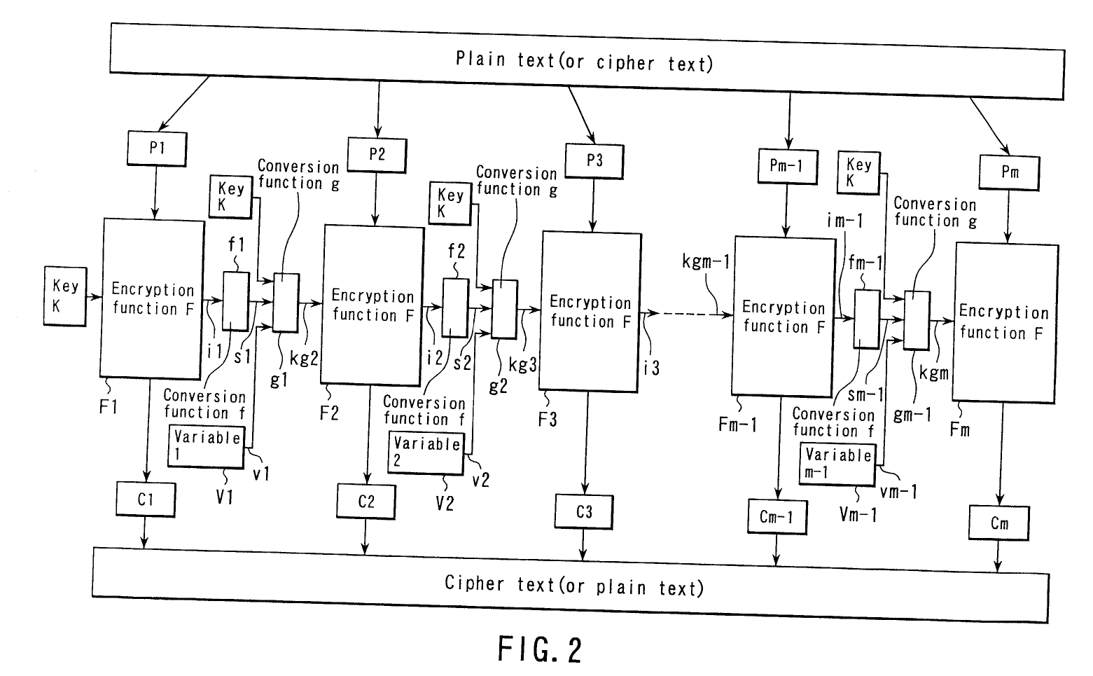

FIG. 2 is a type drawing showing a structure of an encryption/decryption apparatus to which an encryption chaining system according to a first embodiment of the present invention is applied. Like reference numerals denote the same elements as those in FIG. 1 and their detailed explanation is omitted. Here, different elements will be mainly described. It is to be noted that a repetitive description will be similarly omitted in the following respective embodiments.

That is, this embodiment generates different key data Kg2 to Kgm and improves the safety even if plain text blocks P1 to Pm equal to each other are inputted. Specifically, there are provided variable input portions V₁ to Vₘ₋₁ for individually inputting variables v₁ to vₘ₋₁ to the respective conversion functions g₁ to gₘ₋₁.

Here, (m−1) variable input portions V₁ to Vₘ₋₁ have a function for individually inputting the respective variables v₁ to vₘ₋₁ to conversion functions g₁ to gₘ₋₁.

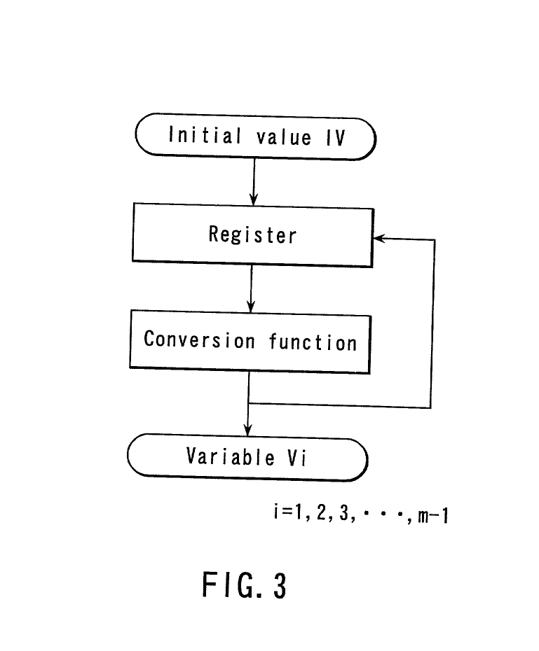

Values which differ in a range from two or more types to (m−1) types as a whole can be set to the respective variables v₁ to vₘ₋₁. The increase in types as a whole is preferable in view of the improvement in the agitation property. For example, as shown in FIG. 3, the respective variables v₁ to vₘ₋₁ can be generated by storing initial values (for example, values inherent to the system) IV in a register and sequentially converting them by the same conversion function.

Moreover, if the number of types of the variables v₁ to vₘ₋₁ is three, setting v₁ to a first value, v₂ to a second value, v₃ to a third value, and v₄ to the first value is more preferable than setting v₁ to v_{(m-1)/3} to the first value, v_{{(m-1)/3}+1} to v_{(m-1)·2/3} to the second value, and v_{{(m-1)·2/3}+1} to vₘ₋₁ to the third value in light of improvements in the agitation property. That is, as to the respective variables v₁ to vₘ₋₁, when t types of values can be obtained, it is preferable to set arbitrary t variables adjacent to each other (for example, v₁ to vₜ, v₂ to vₜ₊₁, . . . , Vₘ₋ₜ to vₘ₋₁) to values different from each other.

It is to be noted that the respective conversion functions g₁ to gₘ₋₁ have a function for converting the additionally inputted common key K based on the variables v₁ to vₘ₋₁ inputted from the variable input portions V₁ to Vₘ₋₁ and the conversion results s₁ to sₘ₋₁ inputted from the conversion functions f₁ to fₘ₋₁, and inputting the obtained conversion results Kg2 to Kgm to the encryption functions F2 to Fm on the next stage. Here, although the respective conversion functions g₁ to gₘ₋₁ execute the conversion procedures equal to each other, individual conversion results s₁ to sₘ₋₁ are generated from the same input since the variables v₁ to vₘ₋₁ are individually used as constants in the conversion procedure. Incidentally, as the conversion function in the respective conversion functions g₁ to gₘ₋₁, the linear function such as the exclusive OR or addition is used as described above.

Further, as the conversion functions f₁ to fₘ₋₁, an arbitrary one among, e.g., the following types of conversion processing (1) to (8) is used.

(1) Bit selection processing for clipping an arbitrary bit length from an input and outputting an obtained result.

(2) Padding processing for padding a dummy bit until the input bit length becomes a necessary bit length. It is to be noted that a redundant character such as blank or 0 can be used as a dummy bit.

(3) Bit inversion processing for inverting and outputting the input bits.

(4) Bit reverse processing for newly arranging the input bits in the reverse order and outputting an obtained result.

(5) Bit replacement processing for arbitrarily replacing the input bits and outputting an obtained result.

(6) Hash function (for example, SHA-1, MD5 and others)+bit selection processing for clipping an arbitrary bit length from a result obtained by converting the input by a hash function and outputting an obtained result.

(7) Constant addition processing for adding a constant to the input and outputting an obtained result.

(8) Identity transformation processing for subjecting the input to identity transformation and outputting an obtained result.

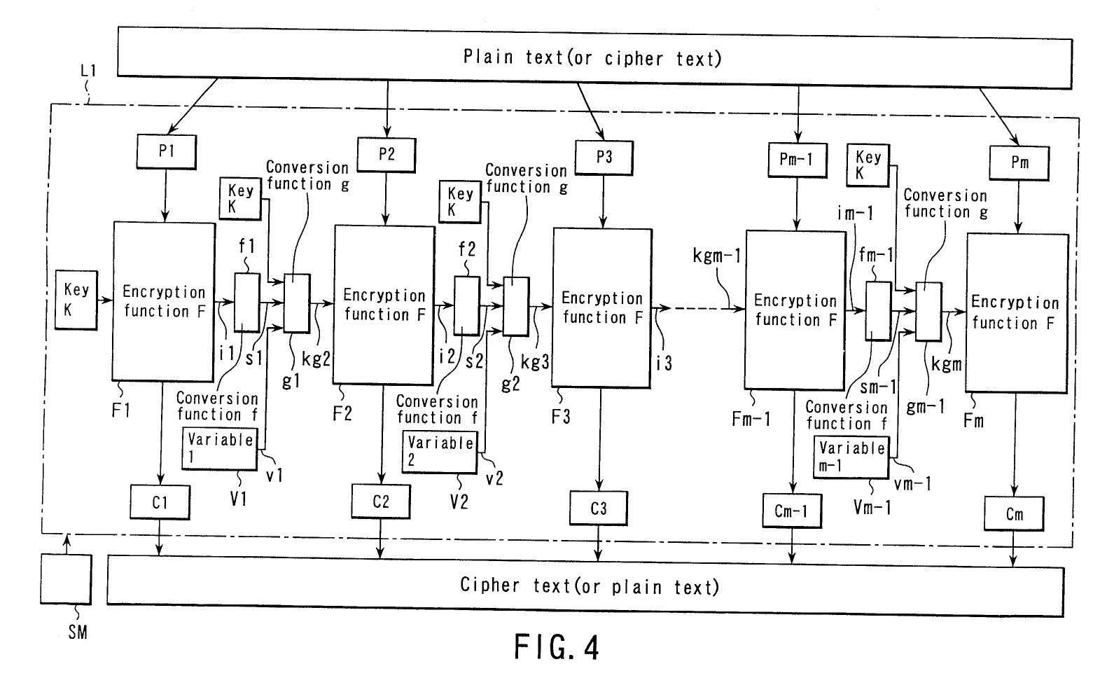

Furthermore, this encryption/decryption apparatus can be realized by hardware and/or software. If this apparatus is realized by software, a program indicating its operation is pre-installed in a computer of the encryption/decryption apparatus from a storage medium. As shown in FIG. 4, this program is pre-stored in the computer-readable storage medium SM, and has a program code for causing the computer to execute the functions surrounded by the dashed line L1. It is to be noted that, in the structure of the data input, this program includes the following (i) but may or may not include (ii).

(i) The structure for inputting plain text or cipher text divided into blocks.

(ii) The structure for dividing an inputted plain text or cipher text into blocks.

The mode for realizing such an encryption/decryption apparatus using hardware/software is similar to a second embodiment described below.

The operation of the encryption/decryption apparatus having the above-mentioned structure will now be described.

Now, in the encryption/decryption apparatus, inputted plain text data is divided into m plain text blocks P1 to Pm having a fixed length as described above, and the respective plain text blocks P1 to Pm are inputted to any of m encryption functions F1 to Fm arranged in parallel to each other.

Moreover, the respective encryption functions F1 to Fm encipher the inputted plain text blocks P1 to Pm by using the key data based on the common key K, convert them into the respective cipher text blocks C1 to Cm and output them.

For example, when the first plain text block P and the common key K are inputted to, the first encryption function F1 inputs the first intermediate output i₁ to the first conversion function f₁ and, on the other hand, outputs the cipher text C1.

The first conversion function f₁ converts the intermediate output i₁ of the encryption function F1 and inputs an obtained conversion result s₁ to the first conversion function g₁.

The above process concerns generation of the key data and is similar to the prior art.

Subsequently, in this embodiment, the first variable input portion V₁ inputs the first variable v₁ to the first conversion function g₁, differing from the prior art.

As a result, the first conversion function g₁ converts the additionally inputted common key K based on the variable v₁ from the variable input portion V₁ and the conversion result s₁ from the conversion function f₁, and inputs an obtained conversion result Kg2 to the encryption function F2 on the next stage.

Therefore, even if the intermediate output i₁ of the first encryption function F1 is 0 and the conversion result s₁ of the first conversion function f₁ is thereby 0, the input to the first conversion function g₁ is not 0 but becomes a variable v₁.

That is, even if the conversion result s₁ of the first conversion function f₁ is 0, the key data Kg2 outputted from the first conversion function g₁ becomes a value obtained by converting the common key K by the variable v₁ and is inputted to the encryption function F2 on the next stage.

Thereafter, similarly, the common key K is converted into the key data Kgn based on the intermediate output iₙ₋₁ by the (n−1)-th encryption function F(n−1), the variable vₙ₋₁ by the (n−1)-th variable input portion Vₙ₋₁, and the (n−1)-th conversion functions fₙ₋₁ and gₙ₋₁, and inputted to the n-th encryption function Fn as the key data Kgn.

The processing for generating the key data Kgn on the next stage from this intermediate output iₙ₋₁ on the preceding stage, the variable vₙ₋₁ on the preceding stage, and the common key K is performed until the key data Kgm is inputted to the m-th encryption function Fm.

Here, the key data Kg2 to Kgm are obtained by converting the common key K based on the variables v₁ to vₘ₋₁ inputted independently from the plain text blocks P1 to Pm or the intermediate results i₁ to iₘ₋₁. Therefore, the encryption/decryption apparatus generates the key data Kg2 to Kgm so as to be values different from each other even if the encryption/decryption apparatus is attacked by a decryption technique by which the respective plain text blocks P1 to Pm are inputted as the same data, thereby preventing the security from lowering.

As described above, according to the present invention, by inputting the variables v₁ to vₘ₋₁ as uncertain elements when generating the key data Kg2 to Kgm in the encryption chaining system, the key data Kg2 to Kgm can not be uniquely determined from the plain text blocks P1 to Pm. That is, since two or more types of methods for chaining between the respective blocks on the whole are provided, generation of the key data different from each other can be guaranteed without providing a device for eliminating the input of a specific pattern, thereby improving the security.

In addition, even if a weak key, a dual key or a semi-weak key is inputted to a given encryption function Fj as the key data Kgj, the key data Kg(j+1) to Kg(m−1) different from the weak key is inputted to the subsequent encryption functions F(j−1) to F(m−1), thereby improving the security.

### Second Embodiment

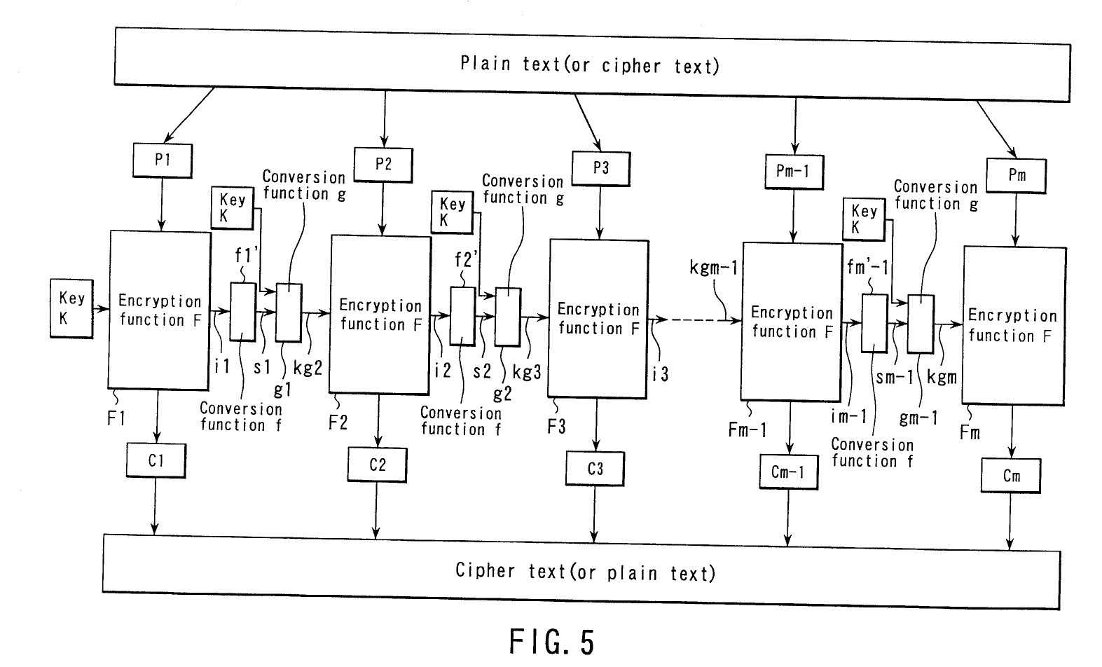

FIG. 5 is a type drawing showing a structure of an encryption/decryption apparatus to which an encryption chaining system according to a second embodiment of the present invention is applied.

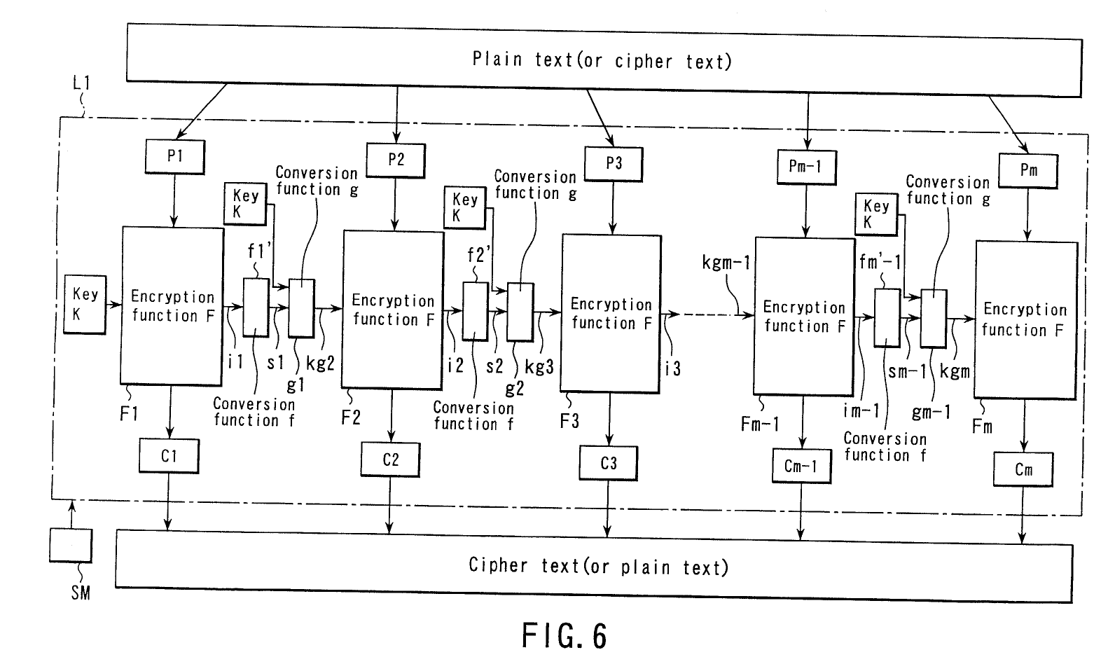

That is, this embodiment is a modification of the first embodiment. Specifically, the respective conversion functions f_{1′} to f_{m-1′} are constituted as any of two or more conversion functions in place of the respective variable input portions V₁ to Vₘ₋₁. Incidentally, similar to the above, when the encryption/decryption apparatus is realized by software, the program concerning the functions surrounded by the dashed line L1 is installed from a storage medium SM as shown in FIG. 6.

Here, as to conversion functions (conversion processing) different from each other, it is possible to apply any of (a) the case of using different functions, (b) the case of causing the same function to act on different bit positions (for example, a bit replacement function), and (c) the case of causing the same function to act with different constants (for example, a constant to be added by an addition function) or combinations of these cases. It is to be noted that the first embodiment corresponds to the example where different conversion functions (conversion processing) g₁ to gₘ₋₁ are used for the conversion functions g₁ to gₘ₋₁ by the above (c).

In addition, as to the respective conversion functions f_{1′} to f_{m-1′}, arbitrary one or more types of conversion processing among the above-described types of conversion processing (1) to (8) can be used, for example.

Incidentally, as for the respective conversion functions f_{1′} to f_{m-1′}, when t types of different functions are applied, it is preferable to set arbitrary t conversion functions adjacent to each other (for example, f_{1′} to f_{t′}, f_{2′} to f_{t+1′}, . . . , f_{m-t′} to f_{m-1′}) to functions different from each other.

Even if the above-described structure is adopted, generation of the key data different from each other can be guaranteed without providing a device for eliminating the input of a specific pattern, thereby improving the safety, similar to the first embodiment.

Further, similarly, when a weak key and like is inputted to a given encryption function Fj as the key data Kgj, the key data Kg(j+1) to Kg(m−1) different from the weak key are inputted to the subsequent encryption functions F(j+1) to F(m−1), thereby improving the safety.

### Third Embodiment

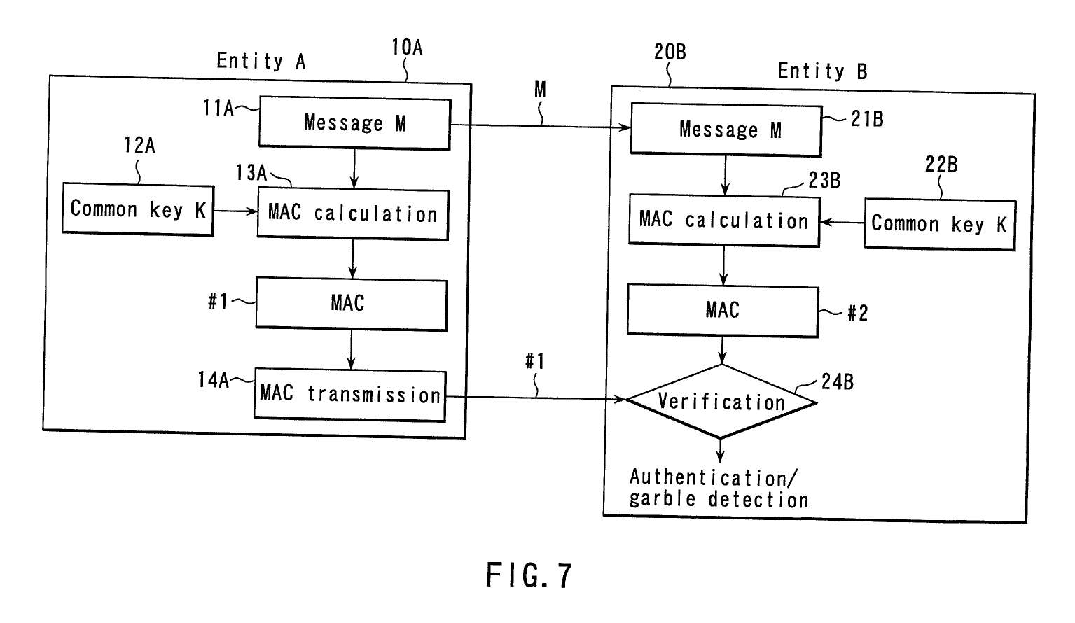

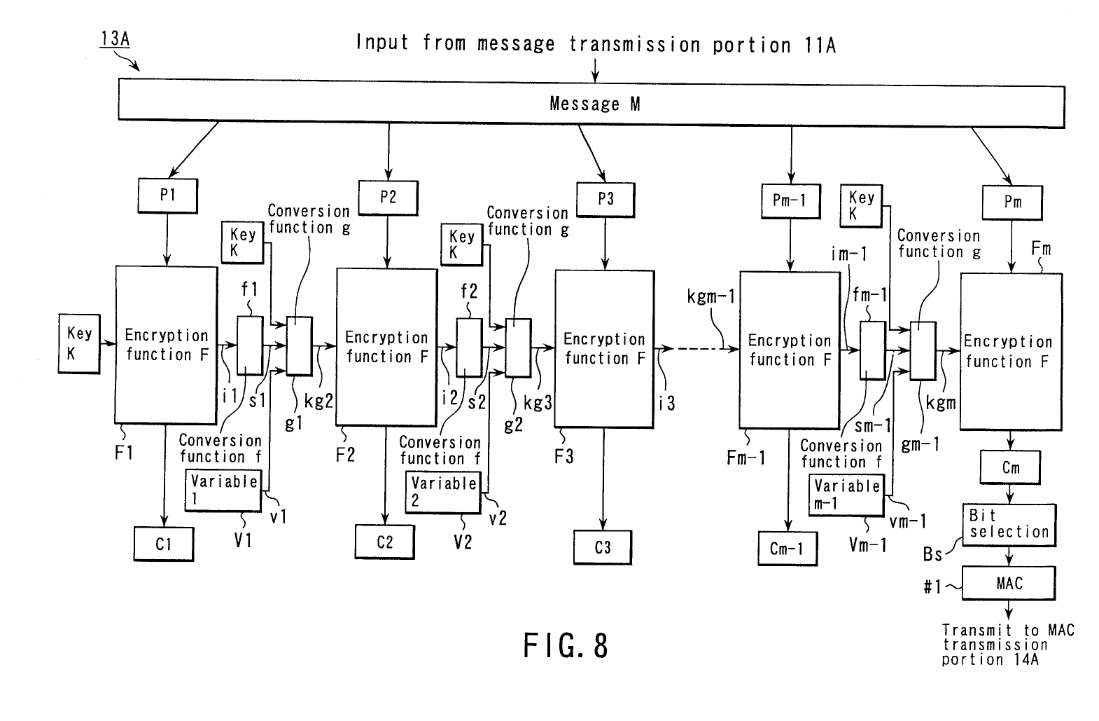

FIG. 7 is a type drawing showing structures of first and second entity devices to which an authenticating system according to a third embodiment of the present invention is applied, and FIG. 8 is a type drawing typically showing a structure of an MAC calculation portion used in each entity device.

That is, this embodiment shows an authenticating system using the encryption/decryption apparatus according to the first embodiment in the MAC calculation portion and has first and second entity devices 10A and 20B.

Here, the first entity device 10A is provided with a message transmission portion 11A, a common key storage portion 12A, an MAC calculation portion 13A, and an MAC transmission portion 14A.

The message transmission portion 11A has a function for transmitting a message M to the second entity device 20B and a function for transmitting the same to its own MAC calculation portion 13A. It is to be noted that the message M may be either a plain text message or a cipher text message.

The common key storage portion 12A is an area in which the common key K shared by both the first and second entity devices 10A and 20B is stored, and can be read from the MAC calculation portion 13A.

The MAC calculation portion 13A has a function for calculating (creating) a first MAC authenticator #1 based on the common key K in the common key storage portion 12A and the message M from the message transmission portion 11A and a function for transmitting the first MAC authenticator #1 to the MAC transmission portion 14A.

The MAC transmission portion 14A has a function for transmitting to the second entity device 20B the first MAC authenticator #1 supplied from the MAC calculation portion 13A.

On the other hand, the second entity device 20B has a message reception portion 21B, a common key storage portion 22B, an MAC calculation portion 23B and a verification portion 24B.

The message reception portion 21B has a function for receiving the message M supplied from the first entity device 10A and transmitting the message M to its own MAC calculation portion 23B.

The common key storage portion 22B is an area in which the common key K shared by both the first and second entity devices 10A and 20B is stored, and can be read from the MAC calculation portion 23B.

The MAC calculation portion 23B has a function for calculating (creating) a second MAC authenticator #2 based on the common key K in the common key storage portion 22B and the message M from the message reception portion 21B and a function for transmitting the second MAC authenticator #2 to the verification portion 24B.

The verification portion 24B has a function for comparing and verifying the second MAC authenticator #2 supplied from its own MAC calculation portion 23B and the first MAC authenticator #1 received from the first entity device 10A, a function for authenticating that the message M created by the first entity device 21B has been received by the message reception portion 21B without being garbled, and a function for detecting that the message M created by the first entity device 10A has been garbled.

A description will now be given of the respective MAC calculation portions 13A and 23B in the first and second entity devices 10A and 20B. It is to be noted that the MAC calculation portions 13A and 23B can be realized by hardware/software. If it is to be realized by software, the program can be loaded from a storage medium and installed when needed. Further, since both MAC calculation portions 13A and 23B have the same structure, a description will be given of the MAC calculation portion 13A in the first entity device 10A as an example.

As shown in FIG. 8, the MAC calculation portion 13A has a structure in which a bit selection portion Bs for selecting data at a predetermined bit position in the m-th (last) cipher text block Cm obtained as mentioned in the first embodiment when the message M is inputted as the plain text data to the encryption/decryption apparatus shown in FIG. 2 is added.

It is to be noted that the bit selection portion Bs has a function for transmitting the selected data to the MAC transmission portion 14A as the first MAC authenticator #1. Furthermore, the message M itself is not restricted to the plain text data and may be cipher text data enciphered by the encryption apparatus equal to or different from the encryption/decryption apparatus depicted in FIG. 2.

Moreover, the above-described first and second entity devices 10A and 20B can be realized by hardware and/or software. When the respective devices 10A and 20B are realized by software, the related program, loaded in a storage medium, is installed into the computers of the respective devices 10A and 20B. Each of the first and second entity devices 10A and 20B may be, for example, a personal computer.

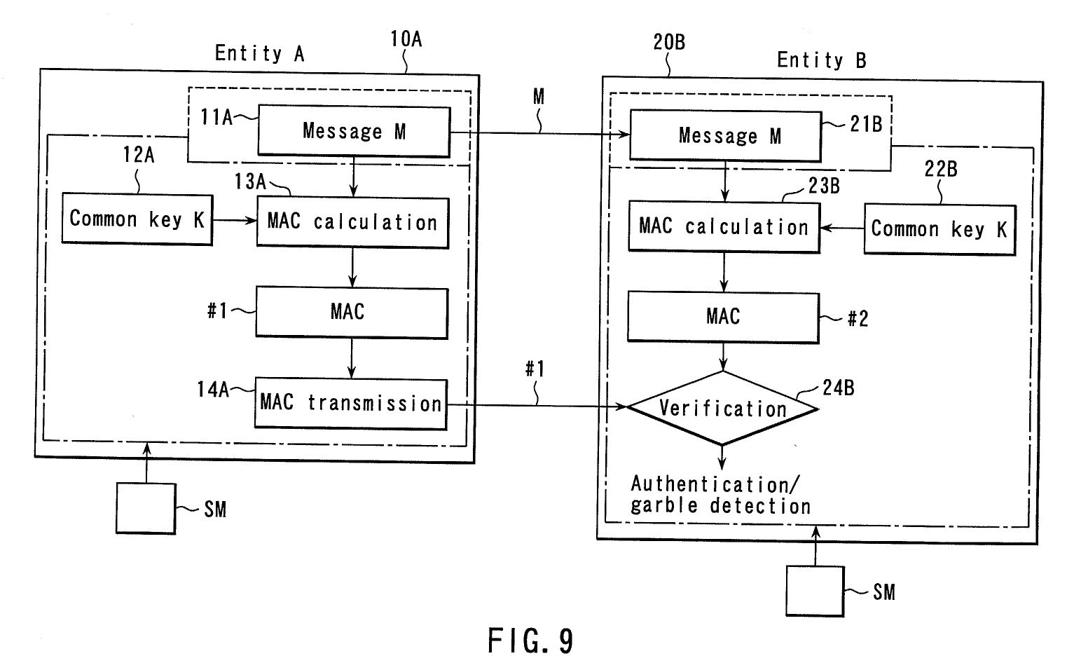

Here, as indicated by the dashed line L1 and the broken line DL in FIG. 9, the program in the storage medium S may or may not include the functions of the message transmission portion 11A and the message reception portion 21B. When the functions of the message transmission portion 11A and the message reception portion 21B are not included in the program in the storage medium SM, they are installed into the personal computer by other means.

In addition, the storage medium SM may store therein only the program for realizing either the device 10A or 20B, or may store therein the program for realizing both devices 10A and 20B.

It is to be noted that the above-described mode for realizing the entity devices by using hardware/software is similar in the following fourth embodiment.

The operation of the first and second entity devices 10A and 20B having the above-mentioned structure will now be described.

In the first entity device 10A, the message transmission portion 11A transmits the message M to the second entity device 20B, and the MAC calculation portion 13A calculates the first MAC authenticator #1 based on the message M and the common key K. Additionally, the MAC transmission portion 14A transmits the first MAC authenticator #1 to the second entity device 20B.

When the second entity device 20B receives the message M and the first MAC authenticator #1 from the first entity device 10A, the MAC calculation portion 23B calculates the second MAC authenticator #2 based on the message M and the common key K.

Subsequently, the verification portion 24B compares and verifies the second MAC authenticator #2 with the received first MAC authenticator #1. When both authenticators #1 and #2 coincide with each other, the verification portion 24B authenticates that the message M created by the first entity device 10A has been received by the message reception portion 21B without being garbled. Further, when both authenticators #1 and #2 do not coincide with each other, the verification portion 24B detects that the message M created by the first entity device 10A has been garbled.

In such an authentication system, the MAC calculation portions 13A and 23B input the variables v₁ to vₘ₋₁ from the respective variable input portions V₁ to Vₘ₋₁ in the process for converting the common key K into the respective key data Kg2 to Kgm, similar to the first embodiment. Therefore, similar to the above description, even if the message M becomes the same plain text (message) blocks P1 to Pm in accordance with each block, the safety can be improved since the key data Kg2 to Kgm become values different from each other.

As described above, according to this embodiment, in the authentication system, since the encryption/decryption apparatus according to the first embodiment is used when calculating the MAC authenticators #1 and #2, the authentication system having the effects of the first embodiment can be realized.

### Fourth Embodiment

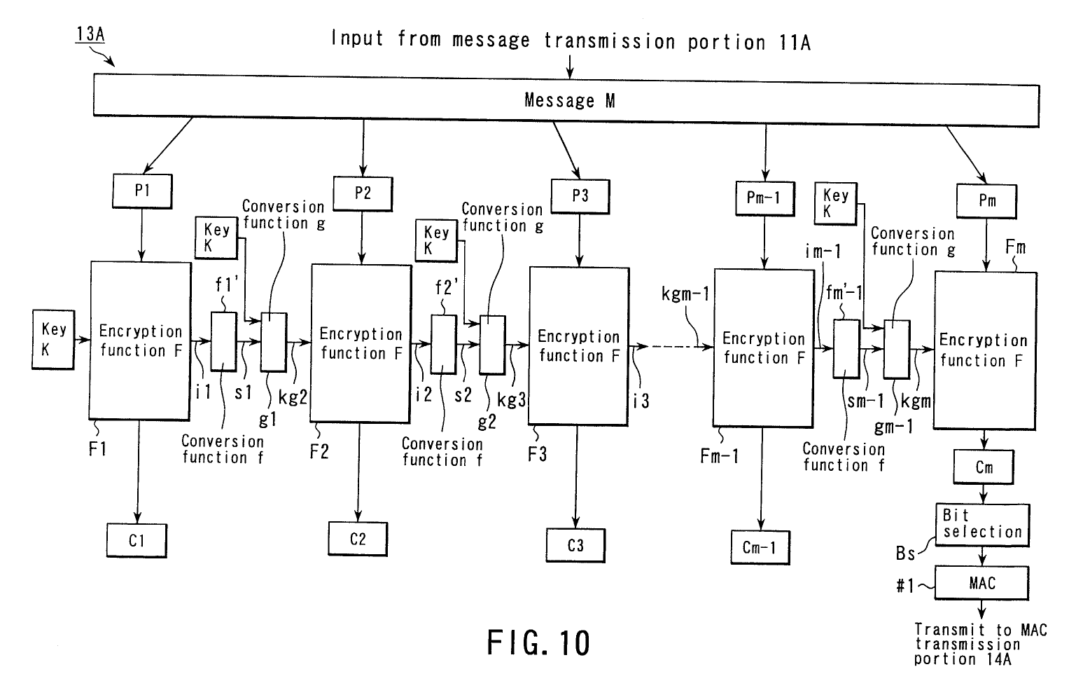

FIG. 10 is a type drawing showing the structure of the MAC calculation portion to which the encryption chaining system according to a fourth embodiment of the present invention is applied.

That is, this embodiment is a modification of the third embodiment. Specifically, in the MAC calculation portions 13A and 23B, the respective conversion functions f_{1′} to f_{m-1′} are constituted as any one of two or more conversion functions different from each other in place of the respective variable input portions V₁ to Vₘ₋₁. Incidentally, although FIG. 10 takes one MAC calculation portion 13A as an example as described above, the other MAC calculation portion 23B has a similar structure.

Here, the conversion functions different from each other are as mentioned in the second embodiment. Furthermore, the respective conversion functions f_{1′} to f_{m-1′} are also as mentioned in the second embodiment.

Even if the above-described structure is adopted, the effects similar to those in the third embodiment can be obtained.

It is to be noted that the apparatus described in the respective foregoing embodiments can be realized by the computer reading the program stored in the storage medium.

Here, as to the storage medium in the present invention, any storage form can be taken as long as it is a storage medium such as a magnetic disk, a floppy disk, a hard disk, an optical memory disk (a CD-ROM, a CD-R, a DVD and others), a magnetic optical disk (an MO and others), a semiconductor memory and the like which can store therein the program and can be read by the computer.

Moreover, an OS (operating system) which operates the computer based on instructions of the program installed in the computer from the storage medium, or MW (middleware) such as database management software or network software may execute a part of each processing for realizing the embodiments.

In addition, the storage medium in the present invention is not restricted to a medium which is independent from the computer, and there is also included a storage medium for storing or temporarily storing therein a program which is transmitted through a LAN or the internet and downloaded.

Additionally, the number of storage mediums is not restricted to one. When the processing in the embodiments is executed from a plurality of mediums, these mediums are also included in the storage medium according to the present invention, and the medium structure can take any form.

Incidentally, the computer in the present invention executes each processing in the embodiments based on the program stored in the storage medium, and may have any structure such as a single device like a personal computer or a system to which a plurality of devices are connected on the network.

Further, the computer in the present invention is not restricted to a personal computer and includes an arithmetic processing unit contained in an information processing device, or a microcomputer and the like, and it is the generic designation of devices and apparatuses capable of realizing the functions of the present invention by the program.

It is to be noted that the present invention is not restricted to the respective foregoing embodiments, and various modifications can be made without departing from its scope in the embodying stage. Furthermore, the respective embodiments can be appropriately combined and realized in any way possible. In such a case, the combined effects can be obtained. Moreover, the foregoing embodiments include the inventions of various stages, and a variety of the inventions can be extracted by appropriately combining a plurality of the disclosed structural requirements. For example, if the present invention is extracted by omitting several structural requirements from all the structural requirements disclosed in the embodiments, the omitted portion is appropriately complemented by a well-known conventional technique when embodying the extracted invention.

Also, the present invention can be modified in many ways to be embodied without departing from its scope.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An encryption/decryption apparatus comprising:
a plurality of encryption function portions which are provided in parallel to each other, output cipher text data by encrypting plain text data based on key data in accordance with each block, and/or output plain text data by decrypting cipher text data based on key data in accordance with each block; and
a plurality of means for generating key data which generate key data by converting a common key based on an intermediate processing result of any encryption function portions and any one of two or more types of conversion processing different from each other, and input generated key data to any encryption function portion which is yet to start processing.

2. The encryption/decryption apparatus according to claim 1, wherein said each conversion processing converts said common key based on any one of two or more variable data different from each other.

3. An encryption/decryption apparatus comprising:
a plurality of encryption function portions which are provided in parallel to each other, output cipher text data by encrypting plain text data based on key data in accordance with each block, and/or output plain data by decrypting cipher text data based on key data in accordance with each block; and
a plurality of key data generation portions configured to generate key data by converting a common key based on an intermediate processing result of any encryption function portion and any one of two or more types of conversion processing different from each other, and input generated key data to any encryption function portion which is yet to start processing.

4. The encryption/decryption apparatus according to claim 3, wherein said each conversion processing converts said common key based on any one of two or more variable data different from each other.

5. An authenticating apparatus for generating an authenticator from a message and authenticating said message based on said authenticator, comprising:
a plurality of encryption function portions which are provided in parallel to each other and create cipher text data by encrypting said message based on key data in accordance with each block;
a plurality of means for generating key data which generate key data by convert a common key based on an intermediate processing result of any encryption function portion and any one of two or more types of conversion processing different from each other, and individually input generated key data to any encryption function portion which is yet to start processing; and
an authenticator generation portion which generates said authenticator based on cipher text data generated by an encryption function portion at a last stage.

6. The authenticating apparatus according to claim 5, wherein said each conversion processing converts said common key based on any one of two or more variable data different from each other.

7. An authenticating apparatus for generating an authenticator from a message and authenticating said message based on said authenticator, comprising:
a plurality of encryption function portions which are provided in parallel to each other, which generate cipher text data by encrypting said message based on key data in accordance with each block;
a plurality of key data generation portions configured to generate key data by converting a common key based on an intermediate processing result of any encryption function portion and any one of two or more types of conversion processing different from each other, and individually input generated key data to any encryption function portion which has yet to start processing; and
an authenticator generation portion which generates said authenticator based on cipher text data generated by an encryption function portion at a last stage.

8. The authenticating apparatus according to claim 7, said each conversion processing converts said common key based on any one of two or more variable data different from each other.

9. A computer program stored in a computer-readable storage medium used in an encryption/decryption apparatus, comprising:
a first program code which causes a computer to sequentially execute a plurality of types of encryption function processing for outputting cipher text data by encrypting plain text data based on key data in accordance with each block and/or outputting plain text data by decrypting cipher text data based on key data; and
a second program code for causing said computer to sequentially execute a plurality of types of key data generation processing for converting a common key based on an intermediate processing result of any encryption function processing and any one of two or more types of conversion processing different from each other and inputting generated key data to any encryption function processing which has yet to start processing.

10. The computer program according to claim 9, wherein said each conversion processing converts said common key based on any one of two or more variable data different from each other.

11. A computer program which generates an authenticator from a message and is stored in a computer-readable storage medium used in an authenticating apparatus for authenticating said message based on said authenticator, comprising:
a first program code for causing a computer to sequentially execute a plurality of types of encryption function processing for generating cipher text data by encrypting said message based on key data in accordance with each block;
a second program code for causing said computer to sequentially execute a plurality of types of key data generation processing for converting a common key based on an intermediate processing result of any encryption function processing and any one of two or more conversion processing different from each other and inputting generated key data to any encryption function processing which is yet to start processing; and
a third program code for causing said computer to execute authenticator generation processing for generating said authenticator based on cipher text data generated by encryption function processing on a last stage.

12. The computer program according to claim 11, wherein said each conversion processing converts said common key based on any one of two or more variable data different from each other.

13. An encryption/decryption method comprising:
outputting cipher text data by subjecting plain text data to encryption processing based on key data in accordance with each block in parallel, and outputting plain text data by subjecting cipher text data to decryption processing based on key data in accordance with each block in parallel; and
generating key data by converting a common key based on an intermediate processing result of encryption processing or decryption processing on a preceding stage and any one of a plurality of types of conversion processing and inputting generated key data to encryption processing or decryption processing on a subsequent stage.

14. The encryption/decryption method according to claim 13, wherein said each conversion processing converts said common key based on any one of a plurality of variable data.

15. An authenticating method for generating an authenticator from a message and authenticating said message based on said authenticator, comprising:
generating cipher text data by subjecting said message to encryption processing based on key data in accordance with each block in parallel;
converting a common key based on an intermediate processing result of encryption processing on a preceding stage and any one of a plurality of types of conversion processing, and individually inputting generated key data to any encryption processing on a subsequent stage; and
generating said authenticator based on cipher text data generated by encryption processing on a last stage.

16. The authenticating method according to claim 15, wherein said each conversion processing converts said common key based on any one of a plurality of variable data.
